(19) United States
(12) Patent Application Publication
(10) Pub. No.: US 2014/0078074 A1
(43) Pub. Date: Mar. 20, 2014

(54) TOUCH PANEL

(71) Applicant: SAMSUNG ELECTRO-MECHANICS CO., LTD., Gyunggi-do (KR)

(72) Inventors: Sang Hwan Oh, Gyunggi-do (KR); Ho Joon Park, Gyunggi-do (KR); Youn Soo Kim, Gyunggi-do (KR); Seung Joo Shin, Gyunggi-do (KR); Jin Uk Lee, Gyunggi-do (KR)

(73) Assignee: SAMSUNG ELECTRO-MECHANICS CO., LTD., Gyunggi-do (KR)

(21) Appl. No.: 13/681,765

(22) Filed: Nov. 20, 2012

(30) Foreign Application Priority Data
Sep. 20, 2012 (KR) 10-2012-0104526

(51) Int. Cl. G06F 3/0488

(52) U.S. Cl. CPC G06F 3/0488
USPC 345/173

(57) ABSTRACT

Disclosed herein is a touch panel. The touch panel includes an electrode pattern that is formed of a combination of unit patterns having protrusions and recessed notches along each side of the electrode pattern.

### CROSS REFERENCE TO RELATED APPLICATION

This application claims the benefit of Korean Patent Application No. 10-2012-0104526, filed on Sep. 20, 2012, entitled “Touch Panel”, which is hereby incorporated by reference in its entirety into this application.

### 1. TECHNICAL FIELD

The present invention relates to a touch panel.

### 2. DESCRIPTION OF THE RELATED ART

With the development of computers using digital technology, computer-assisted devices have been developed, and personal computers, portable transmission devices, information processing devices exclusive for individual, and the like perform a text and graphic process using a variety of input devices such as a keyboard, a mouse, and the like.

However, since the use of the computer has gradually widened due to the rapid progress of an information society, there are difficulties in effectively driving products only using the keyboard and the mouse currently acting as an input device. Accordingly, there is a demand for an input device which has a simple operation and less erroneous operation, and allows information input to be easily performed by anyone.

In addition, in input device-related technologies, concerns have changed toward high reliability, durability, innovativeness, design and processing-related technology, and the like in addition to satisfying general functions. Here, to achieve these purposes, as an input device in which information such as text, graphics, and the like can be input, a touch panel has been developed.

The touch panel is mounted on a display surface of an image display apparatus including a flat panel display device such as an organizer, a liquid crystal display (LCD), a plasma display panel (PDP), an electroluminescence (EL), or the like, and a display such as a cathode ray tube (CRT), and is used to allow a user to select his or her desired information while viewing the image display apparatus.

Types of touch panels are classified into a resistive type, a capacitive type, an electro-magnetic type, a surface acoustic wave (SAW) type, and an infrared type. The touch panels having these various types are applied to electronic products based on problems of signal amplification, resolution difference, the difficulty of design and processing technology, optical characteristics, electrical characteristics, mechanical characteristics, environment resistance characteristics, durability, input characteristics, and affordability, and a resistive touch panel and a capacitive touch panel are currently and widely used.

Meanwhile, as disclosed in Korean Patent No. 2010-0091497 A, research related to the touch panel for forming an electrode pattern using metals have been actively conducted. In this manner, the electrode pattern which is made of the metal has excellent electrical conductivity and has an advantage in that supply/demand is smoothly achieved. However, when the electrode pattern is made of the metal, the electrode pattern should be formed in a mesh structure with sizes in units of micrometer (μm) so as to prevent the electrode pattern from being recognized by a user. However, since the electrode pattern in the mesh structure is configured with straight lines, sharpness is high and a spatial frequency is low. Therefore, there is a problem in that the electrode pattern is easily visually recognized by the user.

### PRIOR ART DOCUMENT

### Patent Document

(Patent Document 1) KR 2010-0091497 A

### SUMMARY OF THE INVENTION

The present invention has been made in an effort to provide a touch panel in which a protrusion or a notch is formed in an electrode pattern, thereby reducing sharpness of the electrode pattern, and increasing a spatial frequency.

According to a first embodiment of the present invention, there is provided a touch panel, including: an electrode pattern that is formed of a combination of unit patterns including protrusions along each side of the electrode pattern.

In addition, the protrusion may be formed so as to extend from the side.

In addition, the protrusion may be formed so as to be spaced apart from the side.

In addition, the protrusion may be provided on both sides with respect to the side.

In addition, the protrusion may be provided alternately on both sides along the side.

In addition, a distal end of the protrusion may be formed in a rounding shape.

In addition, a distal end of the protrusion may be formed in an angular shape.

In addition, the protrusion may be formed in a circular shape.

According to a second embodiment of the present invention, there is provided a touch panel, including: an electrode pattern that is formed of a combination of unit patterns having recessed notches along each side of the electrode pattern.

In addition, the notch may be provided on both sides with respect to the side.

In addition, the notch may be provided alternately on both sides along the side.

According to a third embodiment of the present invention, there is provided a touch panel including: an electrode pattern that is formed of a combination of unit patterns including protrusions and recessed notches along each side of the electrode pattern.

In addition, the protrusion may be formed so as to extend from the side.

In addition, the protrusion may be formed so as to be spaced apart from the side.

In addition, the protrusion may be provided on both sides with respect to the side.

In addition, the protrusion may be provided alternately on both sides along the side.

In addition, a distal end of the protrusion may be formed in a rounding shape.

In addition, a distal end of the protrusion may be formed in an angular shape.

In addition, the protrusion may be formed in a circular shape.

In addition, the notch may be provided on both sides with respect to the side.

In addition, the notch may be provided alternately on both sides along the side.

### BRIEF DESCRIPTION OF THE DRAWINGS

The above and other objects, features and advantages of the present invention will be more clearly understood from the following detailed description taken in conjunction with the accompanying drawings, in which:

FIGS. 1 to 4 are plan views showing a touch panel according to a first embodiment of the present invention;

FIG. 5 is a test chart for evaluating contrast sensitivity in which the human eye has the ability to be able to distinguish patterns.

FIGS. 6 to 8 are cross-sectional views showing the touch panel according to a first embodiment of the present invention;

FIG. 9 is a plan view showing a touch panel according to a second embodiment of the present invention; and

FIG. 10 is a plan view showing a touch panel according to a third embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

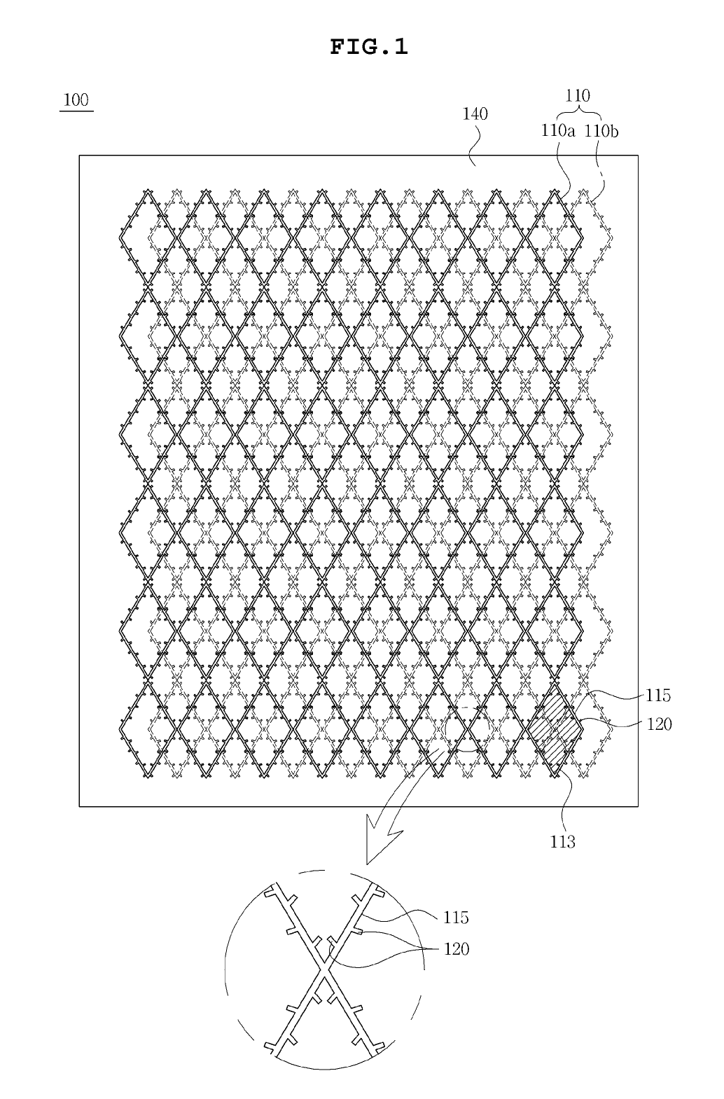

FIGS. 1 to 4 are plan views showing a touch panel according to a first embodiment of the present invention.

As shown in FIGS. 1 to 4, a touch panel 100 according to the first embodiment of the present invention includes an electrode pattern 110 that is formed of a combination of unit patterns 113 having protrusions 120 along each side 115 of the electrode pattern.

The electrode pattern 110 generates a signal when being touched by a user to thereby enable touch coordinates to be recognized in a controller. Here, the electrode pattern 110 may be formed in a fine pattern in units of micrometer (μm) using copper (Cu), aluminum (Al), gold (Au), silver (Ag), titanium (Ti), palladium (Pd), and chromium (Cr), or a combination thereof. In addition, the electrode pattern 110 may include a first electrode pattern 110a and a second electrode pattern 110b. In this instance, the first electrode pattern 110a and the second electrode pattern 110b may be formed on mutually different layers. However, obviously, it is unnecessary that the electrode pattern 110 needs to include both the first and second electrode patterns 110a and 110b, and may include one electrode pattern 110. Meanwhile, the electrode pattern 110 may be formed by a plating process or a deposition process using a sputter. In addition, when the electrode pattern 110 is made of a metal such as copper (Cu) or the like, a surface of the electrode pattern 110 may be subjected to a blackening treatment. Here, the blackening treatment is performed in such a manner that the surface of the electrode pattern 110 is oxidized to thereby extract Cu₂O or CuO. Here, Cu₂O is referred to as brown oxide due to its brown color and CuO is referred to as black oxide due to its black color. In this manner, the surface of the electrode pattern 110 is subjected to the blackening treatment, and therefore light may be prevented from being reflected, and visibility of the touch panel 100 may be accordingly improved. Meanwhile, the electrode pattern 110 may be made of metal silver obtained by exposing/developing a silver salt emulsion layer other than the above-described metal.

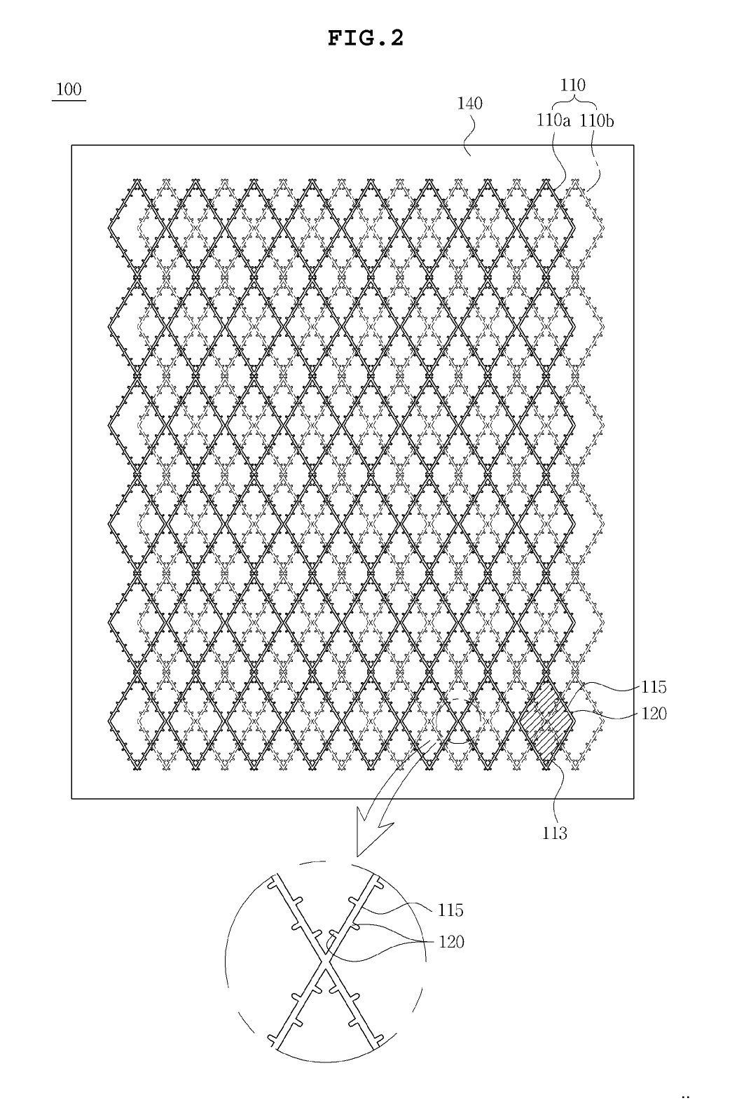

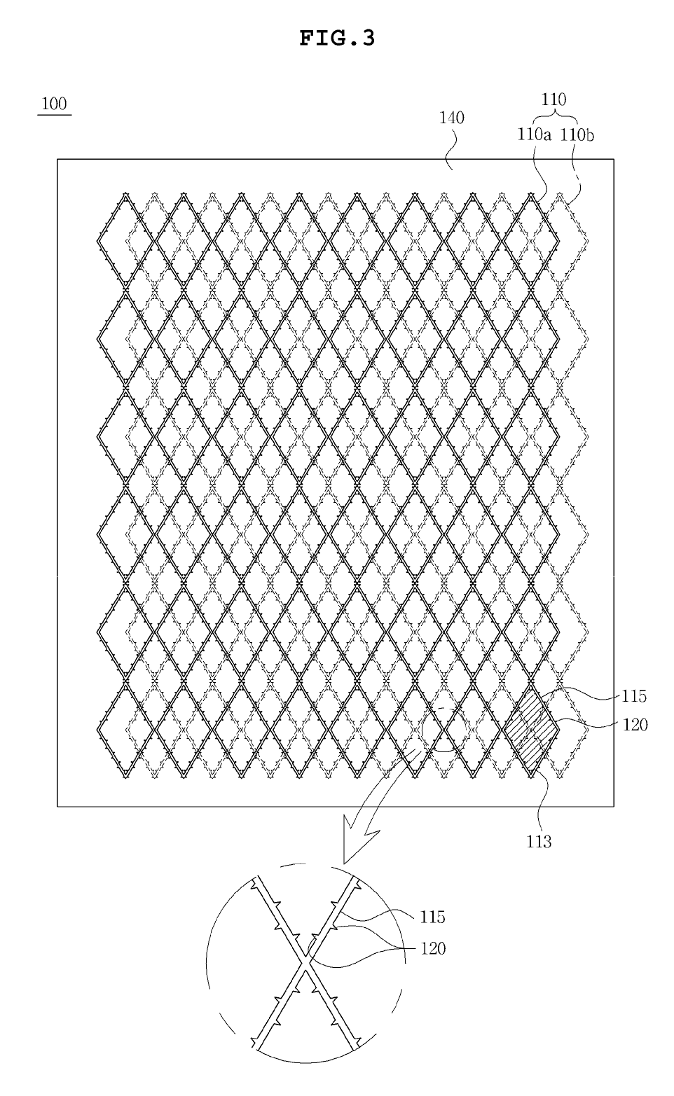

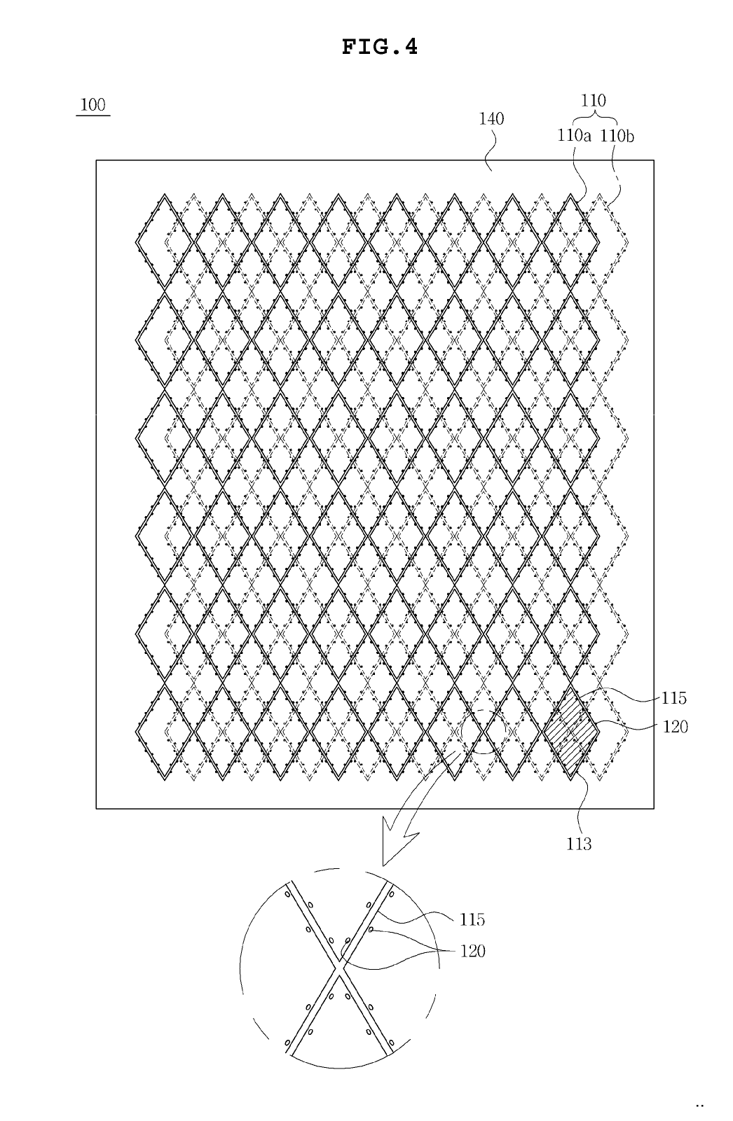

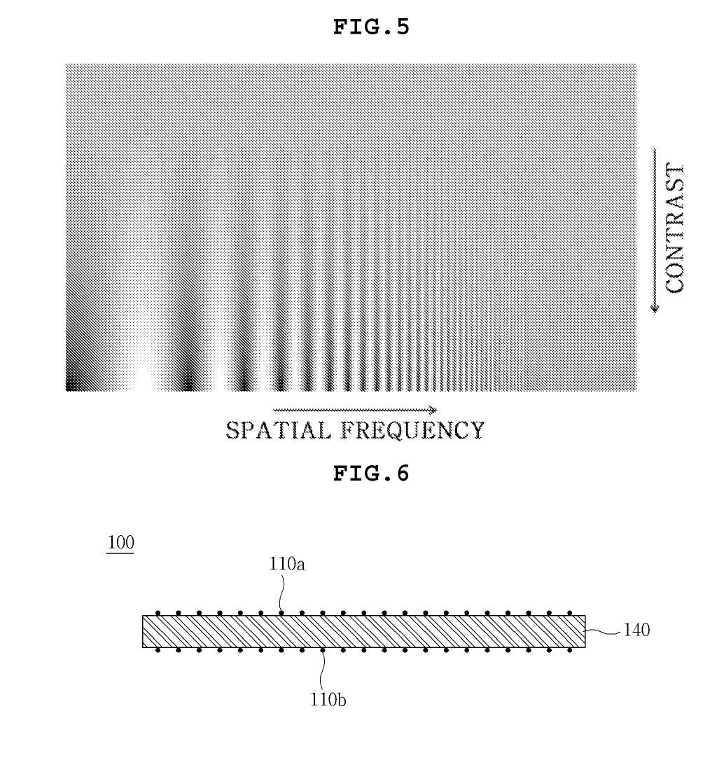

In addition, the electrode pattern 110 may be formed in a mesh structure that is a combination of diamond-shaped unit patterns 113 (hatch lines in the drawing). Here, sides 115 of the unit patterns 113 are typically formed of straight lines, and therefore the electrode pattern 110 may be easily recognized by a user due to high sharpness and a low spatial frequency. Specifically, FIG. 5 is a test chart for evaluating contrast sensitivity of which the human eye has the ability to distinguish patterns, and referring to FIG. 5, a relationship between a spatial frequency and a pattern-distinguishing ability will be described. In FIG. 5, the spatial frequency of a pattern is increased the closer to the right. In addition, the pattern-distinguishing ability is also increased along with an increase in contrast towards the bottom. In this instance, it is found that patterns having low contrast values may be distinguished in low spatial frequencies, whereas it is difficult for patterns even having high contrast values to be distinguished in high spatial frequencies. Considering such a principle, the sides 115 of the unit patterns 113 which are formed of the straight lines have low spatial frequencies to thereby be easily recognized by the user. However, the touch panel 100 according to the first embodiment of the present invention includes protrusions 120 along each side 115 of the unit patterns 113 to thereby increase the spatial frequency, and therefore the electrode pattern 110 is not visually recognized by a user. Here, as shown in FIGS. 1 to 3, the protrusion 120 may be formed so as to extend from the side 115 of the unit patterns 113. In this instance, the protrusion 120 may be typically formed in a rectangular shape (see FIG. 1), but the present invention is not limited thereto. For example, a distal end of the protrusion 120 may be formed in a rounding shape so as to have a curvature (see FIG. 2), or may be formed in an angular shape so as to have sharpness (see FIG. 3). In addition, it is unnecessary that the protrusion 120 may be formed so as to extend from the side 115 of the unit pattern 113, and as shown in FIG. 4, the protrusion 120 may be formed so as to be spaced apart from the side 115. In this instance, the protrusion 120 may be formed in a circular shape. Meanwhile, the protrusion 120 may be provided on both sides with respect to the side 115, and in this instance, the protrusion 120 may be provided alternately on both sides along the side 115 (see FIGS. 1 to 4).

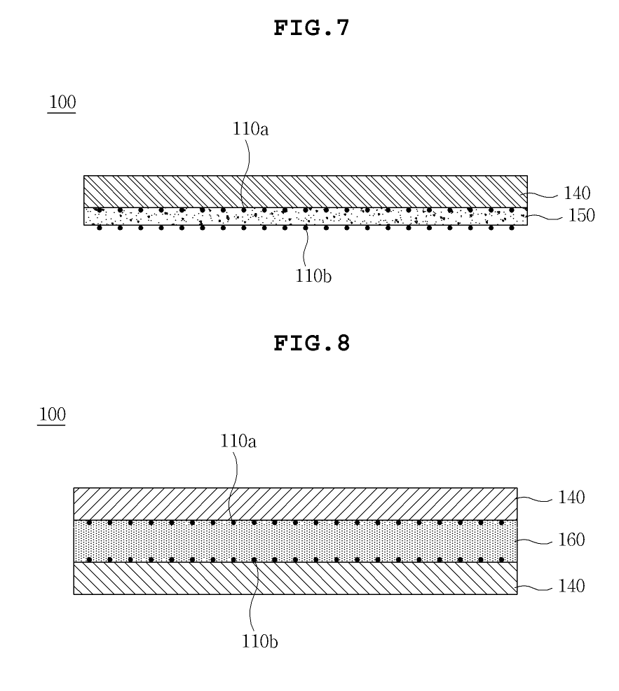

In addition, FIGS. 6 to 8 are cross-sectional views showing a touch panel according to a first embodiment of the present invention. As shown in FIG. 6, the touch panel 100 according to the first embodiment may include a transparent substrate 140 in which a first electrode pattern 110a is formed on one surface thereof and a second electrode pattern 110b is formed on the other surface thereof. Here, the transparent substrate 140 provides an area in which the first and second electrode patterns 110a and 110b are to be formed. However, it is unnecessary that the first and second electrode patterns 110a and 110b are formed on both sides of a single transparent substrate 140. That is, as shown in FIG. 7, an insulating layer 150 is formed on the transparent substrate 140 after forming the first electrode pattern 110a on the transparent substrate 140, and then, the second electrode pattern 110b may be formed on the insulating layer 150. Alternatively, as shown in FIG. 8, two transparent substrates 140 are provided, and then the first electrode pattern 110a and the second electrode pattern 110b may be formed respectively on the two transparent substrates 140. In this case, the two transparent substrates 140 may be adhered by an adhesive layer 160. Meanwhile, the transparent substrate 140 may be made of polyethylene terephthalate (PET), polycarbonate (PC), polymethly methacrylate (PMMA), polyethylene naphthalate (PEN), polyethersulfone (PES), a cyclic olefin polymer (COC), a triacetylcellulose (TAC) film, a polyvinyl alcohol (PVA) film, a polyimide (PI) film, polystyrene (PS), biaxially oriented polystyrene (K resin-containing biaxially oriented PS; BOPS), a glass, a tempered glass, or the like, but is not necessarily limited thereto. In addition, a high frequency treatment or a primer treatment may be performed on the transparent substrate 140 so as to enhance adhesion between the transparent substrate 140 and the electrode pattern 110.

In addition, an electrode wiring that transmits/receives an electrical signal to/from the electrode pattern 110 is formed on an edge of the electrode pattern 110. In this instance, the electrode wiring is integrally formed with the electrode pattern 110 to thereby simplify a manufacturing process and to reduce a lead time. In addition, the electrode wiring is integrally formed with the electrode pattern 110 to thereby omit an adhering process between the electrode wiring and the electrode pattern 110, and therefore there is an effect of preventing problems such as occurrence of steps between the electrode wiring and the electrode pattern 110, adhesion defect and the like in advance.

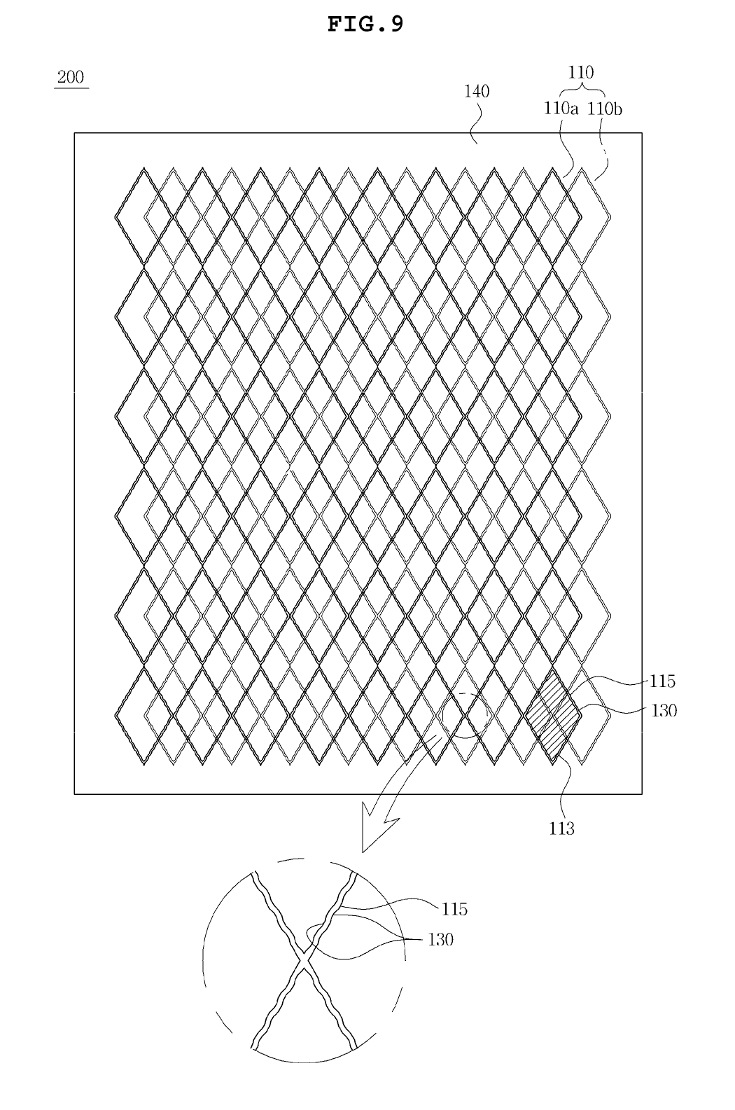

FIG. 9 is a plan view showing a touch panel according to a second embodiment of the present invention.

As shown in FIG. 9, a touch panel 200 according to the second embodiment of the present invention includes an electrode pattern 110 that is formed of a combination of unit patterns 113 having recessed notches 130 along each side 115 of the unit pattern 113. The touch panel 200 according to the second embodiment is different from the touch panel 100 according to the first embodiment in that the notches 130 instead of the protrusions 120 are provided on the electrode pattern 110. Therefore, repeated descriptions between the touch panel 200 according to the second embodiment and the touch panel 100 according to the first embodiment will be omitted, and the notches 130 will be described in detail.

The electrode pattern 110 generates a signal when being touched by a user to thereby enable touch coordinates to be recognized in a controller. Here, the electrode pattern 110 may be formed in a fine pattern in units of micrometer (μm), and the electrode pattern 110 may include a first electrode pattern 110a and a second electrode pattern 110b. Specifically, the electrode pattern 110 having a mesh structure may be formed of a combination of diamond-shaped unit patterns 113 (hatch lines in the drawing). The sides 115 of the unit patterns 113 are formed of straight lines, and therefore the electrode pattern 110 may be easily recognized by a user due to high sharpness and an optically low spatial frequency. However, the touch panel 200 according to the second embodiment includes the recessed notches 130 along each side 115 of the unit patterns 113 to thereby reduce sharpness of the unit patterns 113 formed of straight lines and to increase the spatial frequency, and therefore the electrode pattern 110 may not be visually recognized by the user. Here, the notch 130 may be formed so as to be recessed from the side 115 of the unit patterns 113. In addition, the notch 130 may be formed on both sides with respect to the side 115. In this case, the notches 130 are provided alternately on both sides along the side 115 of the unit patterns 113, and therefore the side 115 of the unit patterns 113 may be recognized as similar to a curve. Therefore, the touch panel 200 according to the second embodiment may further effectively increase the spatial frequency.

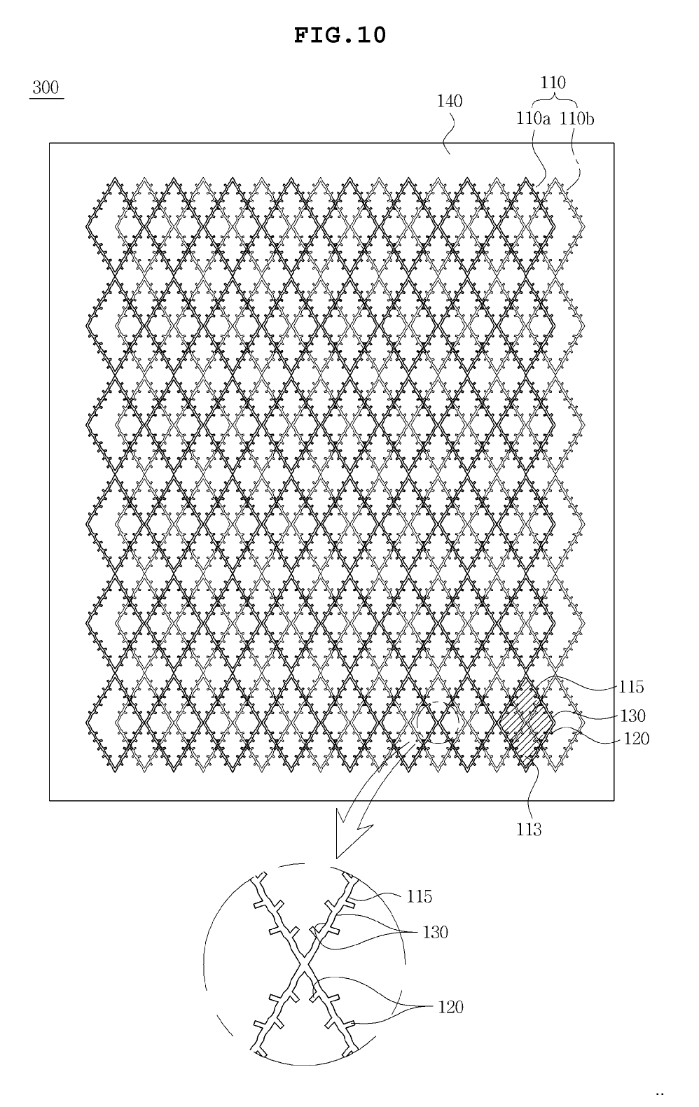

FIG. 10 is a plan view showing a touch panel according to a third embodiment of the present invention.

As shown in FIG. 10, a touch panel 300 according to the third embodiment of the present invention includes an electrode pattern 110 that is formed of a combination of unit patterns 113 having protrusions 120 and recessed notches 130 along each side 115 of the unit patterns 113. The touch panel 300 according to the third embodiment is different from the touch panels 100 and 200 according to the first and second embodiments in that the protrusions 120 and the notches 130 are both provided in the electrode pattern 110. Here, repeated descriptions with the touch panels 100 and 200 according to the first and second embodiments will be omitted, and a configuration in which the protrusions 120 and the notches 130 are both provided will be described.

The electrode pattern 110 generates a signal when being touched by a user to thereby enable touch coordinates to be recognized in a controller. Here, the electrode pattern 110 may be formed in a fine pattern in units of micrometer (μm), and the electrode pattern 110 may include a first electrode pattern 110a and a second electrode pattern 110b. Specifically, the electrode pattern 110 having a mesh structure may be formed of a combination of diamond-shaped unit patterns 113 (hatch lines in the drawing). The sides 115 of such unit patterns 113 are formed of the straight lines, and therefore the electrode pattern 110 may be easily recognized by a user due to high sharpness and a low spatial frequency. However, in the touch panel 300 according to the present embodiment, the protrusions 120 and the recessed notches 130 are both provided along each side 115 of the unit patterns 113 to thereby reduce sharpness of the unit patterns 113 formed of straight lines and to increase the spatial frequency, and therefore the electrode pattern 110 may not be recognized by a user. Here, the protrusion 120 may be formed so as to extend from the side 115 of the unit patterns 113. In this instance, the protrusion 120 may be typically formed in a rectangular shape (see FIG. 10), but the present invention is not limited thereto. For example, a distal end of the protrusion 120 may be formed in a rounding shape so as to have a curvature (see FIG. 2), or may be formed in an angular shape so as to have sharpness (see FIG. 3). In addition, it is unnecessary that the protrusion 120 is formed so as to extend from the side 115 of the unit patterns 113, but may be formed so as to be spaced apart from the side 115 (see FIG. 4). In this instance, the protrusion 120 may be formed in a circular shape. Meanwhile, the protrusion 120 may be provided on both sides with respect to the side 115, and in this instance, the protrusion 120 may be provided alternately on both sides along the side 115 (see FIG. 10). In addition, the notches 130 may be formed so as to be recessed from the side 115 of the unit patterns 113. In this instance, the notch 130 may be formed on both sides with respect to the side 115. In this case, the notches 130 are provided alternately on both sides along the side 115, and therefore the side 115 of the unit patterns 113 may be recognized as similar to a curve. As described above, the touch panel 300 according to the third embodiment includes both the protrusions 120 and the notches 130, thereby more effectively reducing sharpness of the unit patterns 113 including the straight lines, and increasing the spatial frequency. As a result, an effect in which the electrode pattern 110 is not visually recognized by a user may be maximized.

As described above, according to the embodiments of the present invention, the protrusions or the notches are formed on the electrode pattern to thereby reduce sharpness of the electrode pattern and increase the spatial frequency, and therefore the electrode pattern cannot be visually recognized by a user.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A touch panel comprising:
an electrode pattern that is formed of a combination of unit patterns including protrusions along each side of the touch panel.

2. The touch panel as set forth in claim 1, wherein the protrusion is formed so as to extend from the side.

3. The touch panel as set forth in claim 1, wherein the protrusion is formed so as to be spaced apart from the side.

4. The touch panel as set forth in claim 1, wherein the protrusion is provided on both sides with respect to the side.

5. The touch panel as set forth in claim 4, wherein the protrusion is provided alternately on both sides along the side.

6. The touch panel as set forth in claim 2, wherein a distal end of the protrusion is formed in a rounding shape.

7. The touch panel as set forth in claim 2, wherein a distal end of the protrusion is formed in an angular shape.

8. The touch panel as set forth in claim 3, wherein the protrusion is formed in a circular shape.

9. A touch panel comprising:
an electrode pattern that is formed of a combination of unit patterns including recessed notches along each side of the touch panel.

10. The touch panel as set forth in claim 9, wherein the notch is provided on both sides with respect to the side.

11. The touch panel as set forth in claim 10, wherein the notch is provided alternately on both sides along the side.

12. A touch panel comprising:
an electrode pattern that is formed of a combination of unit patterns including protrusions and recessed notches along each side of the touch panel.

13. The touch panel as set forth in claim 12, wherein the protrusion is formed so as to extend from the side.

14. The touch panel as set forth in claim 12, wherein the protrusion is formed so as to be spaced apart from the side.

15. The touch panel as set forth in claim 12, wherein the protrusion is provided on both sides with respect to the side.

16. The touch panel as set forth in claim 15, wherein the protrusion is provided alternately on both sides along the side.

17. The touch panel as set forth in claim 13, wherein a distal end of the protrusion is formed in a rounding shape.

18. The touch panel as set forth in claim 13, wherein a distal end of the protrusion is formed in an angular shape.

19. The touch panel as set forth in claim 14, wherein the protrusion is formed in a circular shape.

20. The touch panel as set forth in claim 12, wherein the notch is provided on both sides with respect to the side.

21. The touch panel as set forth in claim 20, wherein the notch is provided alternately on both sides along the side.
